(19) United States
(12) Patent Application Publication
(10) Pub. No.: US 2021/0372359 A1
(43) Pub. Date: Dec. 2, 2021

(54) SYSTEMS AND APPARATUSES FOR HYDROKINETIC POWER PRODUCTION

(71) Applicant: Robert C. Selby, Columbia, TN (US)

(72) Inventor: Robert C. Selby, Columbia, TN (US)

(21) Appl. No.: 17/222,674

(22) Filed: Apr. 5, 2021

Related U.S. Application Data
(60) Provisional application No. 63/100,200, filed on Mar. 3, 2020.

(51) Int. Cl. F03B 13/10; F03B 11/02; B63B 35/44

(52) U.S. Cl. CPC F03B 13/10; F03B 11/02; F05B 2240/93; B63B 2035/4466; B63B 35/44

(57) ABSTRACT

An apparatus attached to the underside of a barge, a boat, a ship, a buoyant marine structure, and/or the like may include a plurality of conduits. A configuration of the plurality of conduits may increase the velocity of water moving, for example, at a high velocity due to the buoyant force (upward force) under the barge, the boat, the ship, the buoyant marine structure, and/or the like. The water, due to the increased velocity, may cause a plurality of hydroelectric generators to produce a vast amount of electricity and/or power.

### CROSS-REFERENCE TO RELATED PATENT APPLICATION

This application claims priority to U.S. Provisional Application No. 63/100,200 filed Mar. 3, 2020, which is herein incorporated by reference in its entirety.

### BACKGROUND

A longstanding humanitarian objective has been the economical generation of electrical power. More recently, there has been an increase in the public interest to identify environmentally-friendly methods for the generation of electrical power. Hydrokinetic energy (e.g., electricity, power, etc.) generating systems may provide an economical and environmentally-friendly solution for the generation of electricity and/or power. However, the amount of electricity and/or power generated is limited. Current hydrokinetic generating systems have insufficient electricity and/or power generation efficiencies due to changing fluid flow conditions and inherent limitations on the amount of hydrokinetic force that may be produced by a running body of water (e.g., tidal flow, etc.), such as a river.

### SUMMARY

It is to be understood that both the following general description and the following detailed description are exemplary and explanatory only and are not restrictive.

Systems and apparatuses for hydrokinetic power production are described that exponentially magnify electrical energy outputs from electric production equipment (e.g., a hydroelectric generator, a turbine, a super-conductive generator, an electricity generator, etc.). A fluid flowing around the surface of an object, such as a barge, a boat, a ship, and/or the like exerts a force on it. Lift is the component of this force that is perpendicular to the oncoming flow direction. Lift is an exceptional influence for increasing pressure-flow dynamics under barges, boats, ships, and/or the like, asserting millions of lbs./sq. in. of constant pressure on every molecule in flowing fluid (e.g., water, etc.). Increased fluid flow velocity coupled with enormous lift pressure creates one of the strongest natural forces on earth and ranges between 15 to 28 lbs./sq. in. A barge, a boat, a ship, and/or the like may be configured with an apparatus configured with one or more hydrokinetic increasing structures that utilize the effect of lift occurring on the undersurface of the barge, the boat, the ship, and/or the like to significantly increase the amount of energy (e.g., electricity, power, etc.) generated by electric production equipment. The systems and apparatuses for hydrokinetic power production provide can supply tremendous amounts of clean, economical, electricity.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the systems and apparatuses:

FIG. 1 shows an example system;

FIG. 2 shows an example system; and

FIG. 3 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

The systems and apparatuses for hydrokinetic power production described can exponentially magnify electrical energy outputs from electric production equipment (e.g, a hydroelectric generator, a turbine, a super-conductive generator, an electricity generator, etc.). A fluid flowing around the surface of an object, such as a barge, a boat, a ship, and/or the like exerts a force on it. Lift is the component of this force that is perpendicular to the oncoming flow direction. Lift is an exceptional influence for increasing pressure-flow dynamics under barges, boats, ships, and/or the like, asserting millions of lbs./sq. in. of constant pressure on every molecule in flowing fluid (e.g., water, etc.). Increased fluid flow velocity coupled with enormous lift pressure creates one of the strongest natural forces on earth and ranges between 15 to 28 lbs./sq. in. A barge, a boat, a ship, and/or the like may be configured with an apparatus configured with one or more hydrokinetic increasing structures that utilize the effect of lift occurring on the undersurface of the barge, the boat, the ship, and/or the like to significantly increase the amount of energy (e.g., electricity, power, etc.) generated by electric production equipment.

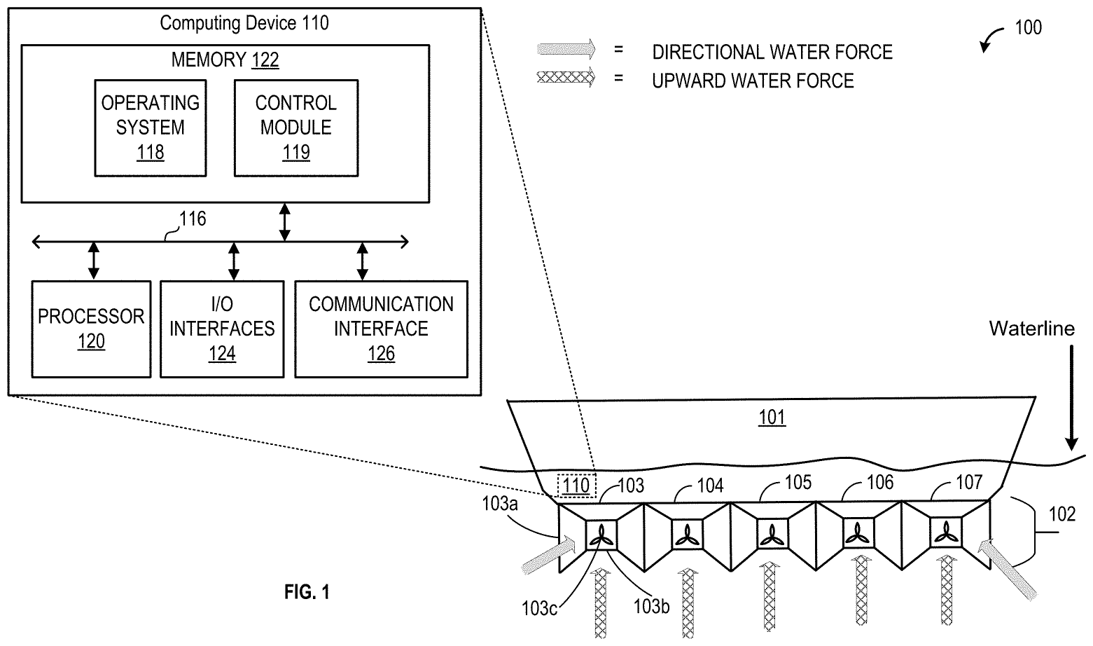

FIG. 1 shows an example system 100 for hydrokinetic power production.

One skilled in the art will appreciate that provided herein is a functional description and that the respective functions may be performed by software, hardware, or a combination of software and hardware.

A barge, a boat, a ship, a water faring vessel, and/or the like, such as a barge 101, may be configured with a hydrokinetic power production (HPP) device 102. The HPP 102 may be grossly constructed from a durable, semi-flexible, waterproof material. FIG. 1 shows a front view of the barge 101. The HPP device 102 may attach to the bottom/underside of the barge 101, for example, below the waterline. For example, the HPP device 102 may include one or more attachment elements (not shown) configured to attach to one or more cleats of the barge 101. The HPP device 102 may attach to the barge 101 and/or be configured with the barge 101 any method.

The HPP device 102 may be and/or include a fluid receptacle configured to capture/intake water from a water body as the barge 101 floats and/or is buoyant upon the water. The HPP device 102 may include a plurality of conduits, such as conduits 103-107. The conduits 103-107 may each be configured to receive water (and/or any other fluid) via a respective inlet and output the fluid via a respective outlet. For example, conduit 103 may receive water (and/or any other fluid) via an inlet 103a and output the fluid via an outlet 103b. The inlet of each of the conduits 103-107, for example, the inlet 103a of the conduit 103, is larger (e.g., comprises a greater area, etc.) than the outlet of the conduits 103-107, for example, the outlet 103b of the conduit 103. The respective sizes of each inlet and outlet of each of the conduits 103-107 cause an increase in fluid velocity passing through each of the conduits 103-107.

The respective sizes of each inlet and outlet of each of the conduits 103-107 may be modified, changed, controlled, and/or the like, for example, by a computing device 120. The computing device 120 may be a digital computer that, in terms of hardware architecture, generally includes a processor 120, memory 122, input/output (I/O) interfaces 124, and communication interfaces 126. These components (120, 122, 124, and 126) are communicatively coupled via a local interface 116. The local interface 116 may be, for example, but not limited to, one or more buses or other wired or wireless connections, as is known in the art. The local interface 116 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 120 may be a hardware device for executing software, particularly that stored in the memory 122. The processor 120 may be any custom made or commercially available processor, a central processing unit (CPU), an auxiliary processor among several processors associated with the computing device 110, a semiconductor-based microprocessor (in the form of a microchip or chipset), or generally any device for executing software instructions. When the HPP 102 and/or the computing device 110 is in operation, the processor 120 may execute software stored within the memory 122, to communicate data to and from the memory 122, and to generally control operations of the HPP 102 and/or the computing device 110 pursuant to the software.

The computing device 120 may include I/O interfaces 224. The I/O interfaces 124 may be used to receive user input from, and/or for providing system output to, one or more devices or components. Input may be provided via, for example, a keyboard, a touchscreen, a voice-activated control, and/or the like. Output may be provided via one or more audio units (e.g., speakers, etc.) and/or a display (e.g., a head unit, a display stack, a heads-up display). The I/O interfaces 124 may include, for example, a serial port, a parallel port, a Small Computer System Interface (SCSI), an infrared (IR) interface, a radio frequency (RF) interface, and/or a universal serial bus (USB) interface.

The communication interface 126 may be used to transmit and receive data/information from the HPP 108 and/or any other device/component. The communication interface 126 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The communication interface 126 may include address, control, and/or data connections to enable appropriate communications on a network (e.g., a wireless network, a cellular network, a packet-switched network, etc.). The communication interface 126 may include one or more circuit transfer switches, power/wattage metters, power inlet/out connectors (e.g., wire connectors, etc.), and/or the like.

The memory 122 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 122 may incorporate electronic, magnetic, optical, and/or other types of storage media. Note that the memory 122 may have a distributed architecture, where various components are situated remote from one another, but may be accessed by the processor 120.

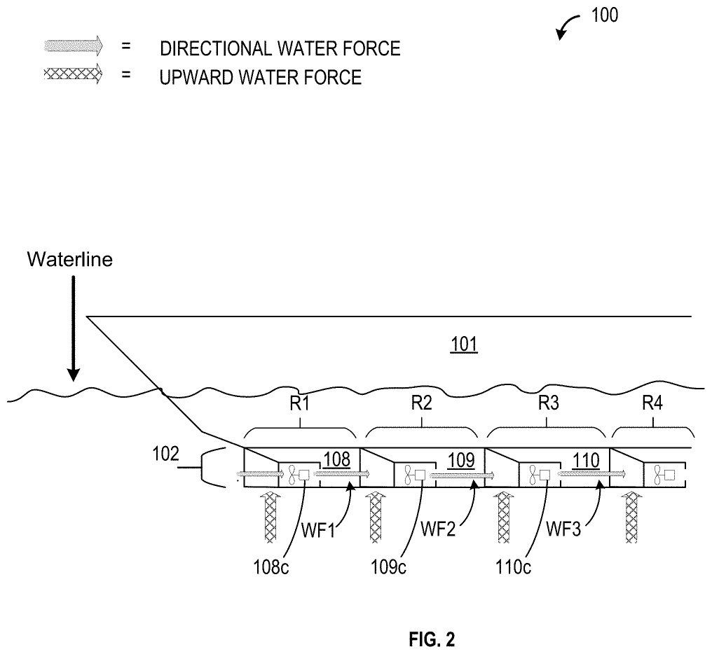

The memory 122 may include one or more software programs, each of which comprises an ordered listing of executable instructions for implementing logical functions. In the example of FIG. 2, the software in the memory 222 may include an operating system 118 and a control module 119. The operating system 118 essentially controls the execution of other computer programs and provides scheduling, input-output control, file and data management, memory management, and communication control, and related services.

For purposes of illustration, application programs and other executable program components such as the operating system 118 are shown herein as discrete blocks, although it is recognized that such programs and components may reside at various times in different storage components of the computing device 110. An implementation of the system 100 may be stored on or transmitted across some form of computer-readable media. Any of the disclosed methods may be performed by computer readable instructions embodied on computer-readable media. Computer-readable media may be any available media that may be accessed by a computer. By way of example and not meant to be limiting, computer-readable media may comprise “computer storage media” and “communications media.” “Computer storage media” may comprise volatile and non-volatile, removable and non-removable media implemented in any methods or technology for storage of information such as computer-readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The control module 119 may control, either individually or collectively, the operation of components/devices of the HPP 102. For example, the control module 119 may control the opening and closing of an outlet (e.g., outlet 103, etc.) for each conduit (e.g., the conduits 103-107, etc.) of the HPP 102. The size of the outlet (e.g., outlet 103, etc.) for each conduit (e.g., the conduits 103-107, etc.) of the HPP 102 may be adjusted/modified by the control module 119. For example, the outlet (e.g., outlet 103, etc.) for each conduit (e.g., the conduits 103-107, etc.) of the HPP 102 may be an electromechanical gate, shutter, opening, and/or the like that, based on an opening/operating position, changes the shape/size of the outlet (e.g., outlet 103, etc.). The change in shape/size of the outlet (e.g., outlet 103, etc.) for each conduit (e.g., the conduits 103-107, etc.) of the HPP 102 relative to the inlet (e.g., inlet 103a, etc.) for each conduit (e.g., the conduits 103-107, etc.) may cause an increase and/or decrease in velocity for water (or any other fluid) passing through the conduit. In an embodiment, the shape/size of the outlet (e.g., outlet 103, etc.) for each conduit (e.g., the conduits 103-107, etc.) of the HPP 102 may be static and/or unchangeable.

Water (or any other fluid) passing through a conduit (e.g., the conduits 103-107, etc.) of the HPP 102, may be water interfacing the HPP 102 via a directional water force and/or an upward water force. The directional water force may be in a direction that is approximately opposite to a direction (e.g., horizontal water pressure, etc.) of movement of the barge 101, for example, as the barge 101 moves in a direction across a body of water. The upward water force (e.g., upthrust, etc.) may be a buoyant force acting upon the barge 101 and/or HPP 102. Each conduit (e.g., the conduits 103-107, etc.) of the HPP 102 may cause an increase and/or decrease in velocity for water (or any other fluid) passing through the conduit, such as water passing through the conduit due to the directional water force and the upward water force, by changing/adjusting the shape/size of the outlet (e.g., outlet 103, etc.).

The increase and/or decrease in velocity for water (or any other fluid) passing through a conduit (e.g., the conduits 103-107, etc.) of the HPP 102 may cause a fluid force exiting the conduit through the outlet (e.g, the outlet 103b, etc.). The fluid force generated/caused by each of the conduits 103-107 may be used to drive a respective hydroelectric generator, such as a turbine, a superconductive generator, and/or the like. For example, a fluid force generated/caused by the conduit 103 may be used to drive a hydroelectric generator 103c (e.g., a turbine, a superconductive generator, etc.). The fluid force may cause the hydroelectric generator 103c to generate electricity.). The HPP 102 may include a plurality of sensors, feedback loops, standard hydroelectric generator controls, and/or control components in communication with the control module 119 that measure operating conditions of each hydroelectric generator of the HPP 102. The control module 119 may fine-tune the operation of the HPP 102, for example, a total amount of electricity generated by the HPP 102, by adjusting the size/shape of one or more outlets of conduits of the HPP 102.

FIG. 1 shows a single row of conduits (e.g, the conduits 103-107, etc.) for the HPP 102. The HPP may include any number/rows of conduits and each conduit may provide a fluid force that drives a hydroelectric generator. FIG. 2 shows a side view of the HPP 102 attached to the barge 101. FIG. 2 shows four rows, R1, R2, R3, and R4 of the HPP 102. The HPP 102 may include multiple rows (e.g., 18-24 rows, etc.) of conduit/hydroelectric generator pairs that cover an entire underside area (e.g., 35 feet×195 feet, etc.) of the barge 101.

Water (or any other fluid) that has passed by and/or driven a hydroelectric generator, may complement (e.g., add to, etc.) the directional water force entering a subsequent conduit of the HPP 102. For example, water that has passed through a conduit 108 and/or a hydroelectric generator 108c in R1 may be forced through the inlet of a conduit 109 in R2 (e.g., a next row of conduits, etc.) of the HPP 102. A water force, WF 1, that has passed through a conduit 108 and/or a hydroelectric generator 108c in R1 may combine with a buoyancy/upward water force as it enters the conduit 109 in the R2. The velocity of water may constantly increase as the water passes through each row of conduits of the HPP 102. For example, the velocity of a WF2 exiting the conduit 109 and/or a hydroelectric generator 109c in R2 may be greater than the velocity of WF1, and a velocity of a WF3 exiting a conduit 110 and/or a hydroelectric generator 110c in R3 may be greater than the velocity of WF1 and WF2. For example, WF3 may be greater than WF1+WF2.

Each hydroelectric generator (e.g., the hydroelectric generator 103c, the hydroelectric generator 108c, the hydroelectric generator 109c, the hydroelectric generator 110c, etc.) associated with each conduit (e.g., the conduits 103-110, etc.) of the HPP 102 may generate electricity. The hydroelectric generators may operate continuously (e.g., twenty-four hours a day, seven days a week, etc.) to generate electricity and/or produce energy. The control module 119 may regulate, manage, and/or control, for example, the amount of electricity generated by each hydroelectric generator by modifying/adjusting the size/shape of the outlet of the conduit to control the fluid force (e.g., WF1, WF2, WF3, etc.) generated by each conduit (e.g., the conduits 103-110, etc.) of the HPP 102 that is used to drive each hydroelectric generator.

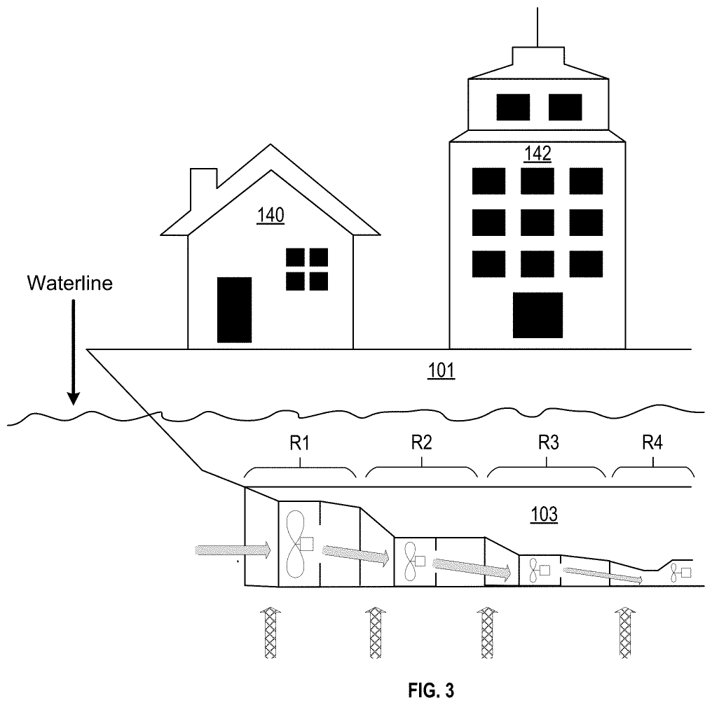

FIG. 3 shows a hydrokinetic power production (HPP) device 103. The HPP 103 may be configured similarly to the HPP 102. The HPP 103 may include rows of conduits, for example, R1-R4. Each row of conduits of the HPP 103 may be succeeded by a row of conduits that include inlets that are smaller in size/shape than the outlet of a previous row of conduits. For example, inlets of conduits in R2 may be smaller than outlets of conduits in R1, inlets of conduits in R3 may be smaller than outlets of conduits in R2, and inlets of conduits in R4 may be smaller than outlets of conduits in R3. The decreasing sizes of the inlets of each row of the HPP 103 may cause a constant increase in water force as water (or any other fluid) passes through rows of the HPP 103.

Electricity generated by each hydroelectric generator of an HPP (e.g., the HPP 102, the HPP 103, etc.) may be stored in one or more batteries, energy storage modules, and/or the like. Electricity generated by each hydroelectric generator may be provided and/or fed to a power grid and/or any other electricity/power distribution system. As shown in FIG. 3, electricity generated by each hydroelectric generator may be provided to one or more structures (e.g., commercial structures, residential structures, industrial structures, multi-use structures/environments, etc.) configured with and/or built on the barge 101, such as a residential structure 140 and/or a commercial structure 142.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. An apparatus comprising:
a fluid receptacle, wherein the fluid receptacle comprises a plurality of conduits, wherein each conduit of the plurality of conduits is configured to:
receive a fluid via an inlet,
cause, based on an area of the inlet being greater than an area of an outlet, an increase in velocity of the fluid as the fluid passes through the conduit, and
cause, based on the increase in the velocity of the fluid passing through the conduit a fluid force; and
a plurality of electric generators, wherein each electric generator of the plurality of electric generators is associated with a conduit of the plurality of conduits, wherein each electric generator of the plurality of electric generators is configured to:
receive the fluid force caused by the associated conduit of the plurality of conduits, and
generate, based on the fluid force, electricity.

2. The apparatus of claim 1, further comprising one or more attachment elements, wherein each of the one or more attachment elements is configured to attach to one or more cleats of at least one of a barge, a boat, or a buoyant marine structure.

3. The apparatus of claim 1, wherein each electric generator of the plurality of electric generators comprise at least one of a hydroelectric turbine and a turbo motor.

4. The apparatus of claim 1, wherein each electric generator of the plurality of electric generators configured to generate electricity comprises each electric generator of the plurality of electric generators further configured to convert mechanical energy generated by the fluid force caused by the associated conduit into electricity.

5. The apparatus of claim 1, wherein the fluid receptacle further comprises another plurality of conduits, wherein each conduit of the another plurality of conduits is configured to:
receive the fluid from the outlet of a conduit of the plurality of conduits via an inlet,
cause, based on an area of the inlet being greater than an area of an outlet, an increase in the velocity of the fluid received from the conduit of the plurality of conduits as the fluid passes through the conduit of the another plurality of conduits, and
cause, based on the increase in the velocity of the of the fluid received from the conduit of the plurality of conduits, an increase to the fluid force associated with the fluid received from the conduit of the plurality of conduits.

6. The apparatus of claim 5, further comprising another plurality of electric generators, wherein each electric generator of the another plurality of electric generators is associated with a conduit of the another plurality of conduits, wherein each electric generator of the another plurality of electric generators is configured to:
receive the increased fluid force caused by the associated conduit of the another plurality of conduits, and
generate, based on the increased fluid force, electricity.

7. An apparatus comprising:
a fluid receptacle, wherein the fluid receptacle comprises a plurality of conduits, wherein each conduit of the plurality of conduits is configured to:
receive a fluid via an inlet,
cause, based on an area of the inlet being greater than an area of an outlet, an increase in velocity of the fluid as the fluid passes through the conduit, and
cause, based on the increase in the velocity of the fluid passing through the conduit a fluid force;
a plurality of electric generators, wherein each electric generator of the plurality of electric generators is associated with a conduit of the plurality of conduits, wherein each electric generator of the plurality of electric generators is configured to:
receive the fluid force caused by the associated conduit of the plurality of conduits, and
generate, based on the fluid force, electricity; and
one or more processors; and
memory storing processor-executable instructions that, when executed by the one or more processors, cause the apparatus to:
determine an amount of electricity stored by each energy storage device of a plurality of energy storage devices; and
send, based on the amount of electricity stored by each energy storage device of the plurality of energy storage devices, at least a portion of the electricity generated the plurality of electric generators to one or more energy storage devices of the plurality of energy storage devices.

8. The apparatus of claim 7, further comprising one or more attachment elements, wherein each of the one or more attachment elements is configured to attach to one or more cleats of at least one of a barge, a boat, or a buoyant marine structure.

9. The apparatus of claim 7, wherein each electric generator of the plurality of electric generators comprise at least one of a hydroelectric turbine and a turbo motor.

10. The apparatus of claim 7, wherein the fluid receptacle further comprises another plurality of conduits, wherein each conduit of the another plurality of conduits is configured to:
receive the fluid from the outlet of a conduit of the plurality of conduits via an inlet,
cause, based on an area of the inlet being greater than an area of an outlet, an increase in the velocity of the fluid received from the conduit of the plurality of conduits as the fluid passes through the conduit of the another plurality of conduits, and
cause, based on the increase in the velocity of the of the fluid received from the conduit of the plurality of conduits, an increase to the fluid force associated with the fluid received from the conduit of the plurality of conduits.

11. The apparatus of claim 10, further comprising another plurality of electric generators, wherein each electric generator of the another plurality of electric generators is associated with a conduit of the another plurality of conduits, wherein each electric generator of the another plurality of electric generators is configured to:
receive the increased fluid force caused by the associated conduit of the another plurality of conduits, and
generate, based on the increased fluid force, electricity.

12. An apparatus comprising:
a fluid receptacle, wherein the fluid receptacle comprises a plurality of conduits, wherein each conduit of the plurality of conduits is configured to:
receive a fluid via an inlet,
cause, based on an area of the inlet being greater than an area of an outlet, an increase in velocity of the fluid as the fluid passes through the conduit, and
cause, based on the increase in the velocity of the fluid passing through the conduit a fluid force;
a plurality of electric generators, wherein each electric generator of the plurality of electric generators is associated with a conduit of the plurality of conduits, wherein each electric generator of the plurality of electric generators is configured to:
receive the fluid force caused by the associated conduit of the plurality of conduits, and
generate, based on the fluid force, electricity; and
one or more processors; and
memory storing processor-executable instructions that, when executed by the one or more processors, cause the apparatus to:
determine an amount of electricity generated by each electric generator of the plurality of electric generators; and
modify, based on the amount of electricity generated by each electric generator of the plurality of electric generators, the area of the outlet of one or more conduits of the plurality of conduits.

13. The apparatus of claim 12, further comprising one or more attachment elements, wherein each of the one or more attachment elements is configured to attach to one or more cleats of at least one of a barge, a boat, or a buoyant marine structure.

14. The apparatus of claim 12, wherein each electric generator of the plurality of electric generators comprise at least one of a hydroelectric turbine and a turbo motor.

15. The apparatus of claim 12, wherein each electric generator of the plurality of electric generators configured to generate electricity comprises each electric generator of the plurality of electric generators further configured to convert mechanical energy generated by the fluid force caused by the associated conduit into electricity.

16. The apparatus of claim 12, wherein the fluid receptacle further comprises another plurality of conduits, wherein each conduit of the another plurality of conduits is configured to:
receive the fluid from the outlet of a conduit of the plurality of conduits via an inlet,
cause, based on an area of the inlet being greater than an area of an outlet, an increase in the velocity of the fluid received from the conduit of the plurality of conduits as the fluid passes through the conduit of the another plurality of conduits, and
cause, based on the increase in the velocity of the of the fluid received from the conduit of the plurality of conduits, an increase to the fluid force associated with the fluid received from the conduit of the plurality of conduits.

17. The apparatus of claim 16, wherein, for each conduit of the another plurality of conduits, the area of the inlet is lesser than the area of the outlet of the conduit of the plurality of conduits.

18. The apparatus of claim 16, further comprising another plurality of electric generators, wherein each electric generator of the another plurality of electric generators is associated with a conduit of the another plurality of conduits, wherein each electric generator of the another plurality of electric generators is configured to:
receive the increased fluid force caused by the associated conduit of the another plurality of conduits, and
generate, based on the increased fluid force, electricity.

19. The apparatus of claim 12, wherein, for each conduit of the one or more conduits, the modified area of the outlet causes an increase in the fluid force caused by the outlet, wherein the increase in the fluid force causes an increase in an amount of the electricity generated by the associated electric generator of the plurality of electric generators.

20. The apparatus of claim 12, wherein, for each conduit of the one or more conduits, the modified area of the outlet causes a decrease in the fluid force caused by the outlet, wherein the decrease in the fluid force causes a decrease in an amount of the electricity generated by the associated electric generator.
